(19) United States
(12) Patent Application Publication
(10) Pub. No.: US 2024/0180129 A1
(43) Pub. Date: Jun. 6, 2024

(54) AQUARIUM CLEANER HAVING STRUCTURE FOR SUCTIONING, SEPARATING AND DISCHARGING MIXED FLOW OF AQUARIUM FLOOR MATERIALS

(71) Applicant: EASYX CO., LTD., Cheonan-si (KR)

(72) Inventors: Dae Bong KIM, Asan-si (KR); Kyoung Hun SHIN, Asan-si (KR)

(73) Assignee: EASYX CO., LTD., Cheonan-si (KR)

(21) Appl. No.: 18/439,394

(22) Filed: Feb. 12, 2024

Related U.S. Application Data
(63) Continuation of application No. PCT/KR2022/012094, filed on Aug. 12, 2022.

(30) Foreign Application Priority Data
Aug. 12, 2021 (KR) 10-2021-0106899

(51) Int. Cl. A01K 63/10; A01K 63/04; B01D 35/28

(52) U.S. Cl. CPC A01K 63/10; A01K 63/045; A01K 63/047; B01D 35/28

(57) ABSTRACT

The present disclosure relates to an aquarium cleaner, and provided is the aquarium cleaner comprising: a hollow body including a suction port, a water outlet and a floor material discharge port; a connection part formed at one end of the body and connected to a power-providing means; a rotary shaft, which extends in the direction traversing the longitudinal center in the body, and has a portion exposed from the body so as to be rotated by means of power; a propeller, which is coupled to be linked to the rotary shaft, and transfers fluid toward the water outlet through the suction port as the rotary shaft rotates by means of power; and a floor material filter, which is coupled to the rotary shaft so as to be angularly spaced from the extension direction of the rotary shaft, and is positioned on a fluid transfer path.

### CROSS-REFERENCE TO RELATED APPLICATIONS

This application is a continuation of International Patent Application No. PCT/KR2022/012094, filed on Aug. 12, 2022, which is based upon and claims the benefit of priority to Korean Patent Application No. 10-2021-0106899 filed on Aug. 12, 2021, in the Korean Intellectual Property Office, the disclosure of which is incorporated herein by reference.

### BACKGROUND OF THE INVENTION

### Field of the Invention

The present invention relates to a fish bowl cleaner that can be used as an aquarium cleaner having structure for suctioning, separating and discharging mixed flow of aquarium floor materials.

### Description of the Related Art

A fish bowl cleaner is used to remove foreign substances created by feed, fish excrement, and microbial growth in a fish bowl, and to purify water contained in the fish bowl to maintain a more comfortable environment in the fish bowl. In the process of introducing water into the fish bowl cleaner to purify the water, a bottom material placed in the fish bowl may also be sucked. If the bottom material is excessively sucked, the bottom material passes through a pump to a purification filter, and the bottom material blocks a filter, thereby preventing the filter from functioning sufficiently. To prevent this, a typical fish bowl cleaner is designed to have only moderate suction power, and must be used to suction the bottom material only up to the end of a suction port, then lift the cleaner upward so that the bottom material falls by its own weight. For this reason, existing fish bowl cleaners require a long time and effort for cleaning. Another conventional example is a cleaner that moves water outside the fish bowl to purify the water inside the fish bowl. These cleaners are inconvenient because they require a separate water tray and drain hose, and it is difficult to avoid the inconvenience of having to re-supply water into the fish bowl. Therefore, there is a need for a functionally improved fish bowl cleaner that purifies the water in the fish bowl, prevents the bottom material from blocking the filter, and allows the purified water to immediately flow into the fish bowl.

### SUMMARY OF THE INVENTION

An object of an exemplary embodiment of the present invention is to quickly and strongly remove contaminants generated and deposited inside a fish bowl.

The present invention relates to a fish bowl cleaner, and provided is a fish bowl cleaner which includes: a hollow body including a suction port, a bottom material discharge port, and a water outlet; a driving unit which is a means which is coupled to one end of the water outlet side of the body, and provides power; a connector connecting the body and the driving unit, a rotary shaft rotated by the power while passing through a center of a longitudinal direction of the inside of the body; a first propeller coupled to the rotary shaft, and sucking water and a bottom material through the suction port as the rotary shaft is rotated by the driving unit; a bottom material strainer installed across an internal cross-section of the body; a second propeller positioned at an upper portion (water outlet side) of the bottom material strainer, coupled to the rotary shaft, and returning water passing through the bottom material strainer to a fish bowl as the rotary shaft is rotated by the driving unit; and a bottom material strainer installed inside the body or outside the water outlet, and purifying contaminants.

In addition, the body may further include a bottom material discharge port opened so that a bottom material introduced through the suction port jointly with the water may be discharged to the outside of the body.

Further, the bottom material strainer may be disposed to be tilted in a suction movement direction of the fluid so that the sucked bottom material is guided to the discharge port.

Further, in respect to the bottom material and the water sucked into the suction port, a second path in which only contaminants and water are moved to the water outlet or the bottom material strainer are moved, and filtered or returned, and a first path in which the bottom material and the water are moved from the suction port to the bottom material discharge port, and unfiltered.

In addition, the driving unit may transfer rotary force to the rotary shaft by using electric motor rotary force or using rotary force from a third propeller which is rotated by suction force of a cleaner or discharge force of compressed air.

Further, the fish bowl cleaner may further include a support part supporting the rotary shaft to be freely rotatable inside the body.

According to an exemplary embodiment of the present invention, a fish bowl cleaner can be provided, which can quickly and strongly remove contaminants generated and deposited inside a fish bowl.

### BRIEF DESCRIPTION OF THE DRAWINGS

FIG. 1 is a diagram illustrating that a fish bowl cleaner is used according to an exemplary embodiment of the present invention;

FIG. 2 is a perspective view of the fish bowl cleaner according to an exemplary embodiment of the present invention;

FIGS. 3A and 3B are perspective cross-sectional views of the fish bowl cleaner according to an exemplary embodiment of the present invention;

FIG. 4 is a front cross-sectional view of the fish bowl cleaner according to an exemplary embodiment of the present invention;

FIG. 5 is a diagram illustrating a flow of a fluid passing through a bottom material strainer according to an exemplary embodiment of the present invention;

FIG. 6 is a perspective view of a fish bowl cleaner according to another embodiment of the present invention; and

FIGS. 7A and 7B are diagrams illustrating a connector connected to a driving unit according to another embodiment of the present invention.

### DETAILED DESCRIPTION OF THE PREFERRED EMBODIMENT

Hereinafter, a specific exemplary embodiment of the present invention will be described with reference to the accompanying drawings. However, this is just an example and the present invention is not limited thereto.

In describing the present invention, a detailed description of the known art related with the present invention will be omitted when it is judged that the detailed description may unnecessarily make the gist of the present invention unclear. In addition, terms to be described below as terms which are defined in consideration of functions in the present invention may vary depending on the intention of a user or an operator or usual practice. Accordingly, the terms need to be defined based on contents throughout this specification.

The technical idea of the present invention is determined by the claims, and the following embodiments are just one means for efficiently explaining the technical idea of the present invention to those skilled in the art to which the present invention belongs.

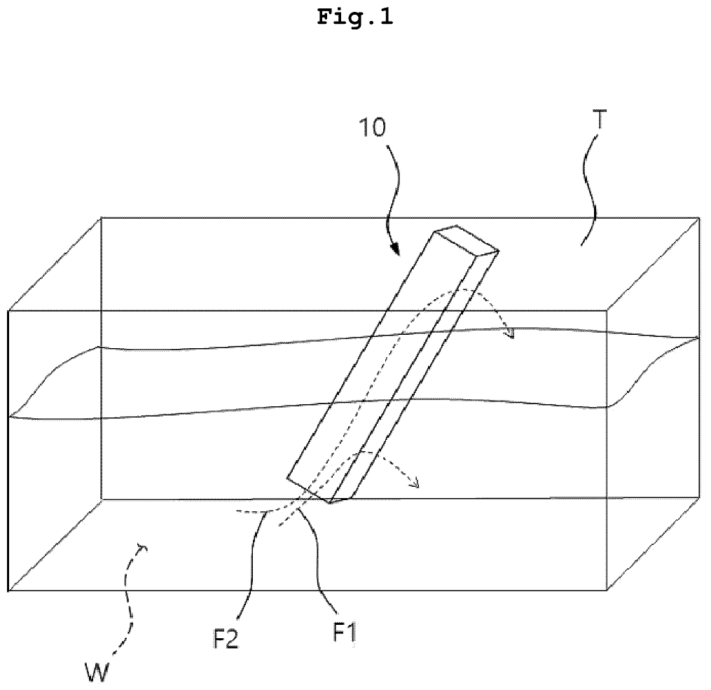

FIG. 1 is a diagram illustrating that a fish bowl cleaner 10 is used according to an exemplary embodiment of the present invention.

Referring to FIG. 1, the fish bowl cleaner 10 of the present invention may be used by being at least partially immersed in a fish bowl T. The fish bowl cleaner 10 can remove contaminants mixed in the water in the fish bowl by passing the water contained in the fish bowl T, filtering foreign substances, and re-supplying the purified water to the fish bowl. Additionally, if purification work is not performed for a relatively long period of time, contaminants deposited on the bottom material in the fish bowl T may be generated. Therefore, a fluid W sucked into the fish bowl cleaner 10 may be water mixed with the bottom material in the fish bowl T, such as dirt and gravel. Contaminants deposited on the sucked bottom material may be peeled off by contact with an internal structure of the fish bowl cleaner 10, and the peeled off contaminants may be moved and filtered according to the flow of the fluid W.

Here, the fluid flow formed through the present invention may be divided into two types. The fluid flow may be a first fluid flow F1 and a second fluid flow F2 illustrated in FIG. 1. The first fluid flow F1 and the second fluid flow F2 will be described through the following embodiments, and when first and second fluid flows are described in brief, the fluid flow may be divided into the first fluid flow F1 which is a flow for discharging the bottom material without passing through a filtering process by the fluid and a second fluid flow F2 which is a flow to filter contaminants from the fluid and return the fluid W to the fish bowl 10.

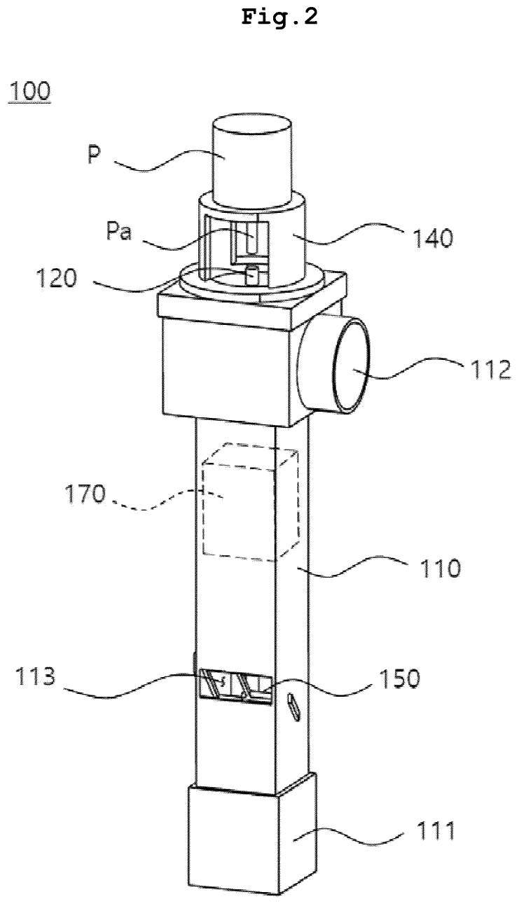

Referring to FIG. 2, the fish bowl cleaner 100 may include a body 110 in which a suction port 111, a water outlet 112, and a bottom material discharge port 113 are formed. The suction port 111 side of the body 110 is immersed in the water to allow water and part of the bottom material to be introduced into the body 110. Here, the fish bowl cleaner 100 may further include a driving unit P that provides power so that the fluid W may be sucked, and the driving unit P may be an electric motor or a cleaner in an exemplary embodiment of the present invention. Rotational force may be generated by the power generated by the driving unit P.

That is, the rotary force is provided to suck the fluid W into the body 110. The sucked fluid W may be moved to the outside of the body 110 through the water outlet 112 and the bottom material discharge port 113. As described above, the water moved to the water outlet 112 is a fluid W in which foreign substances are filtered by a filter unit 170 through a bottom material strainer 150 positioned in the body 110. One or more filter units 170 may be selectively installed inside the body 110 or outside the water outlet 112 to filter contaminants floating in the fluid W, and to explain the present invention, the present invention will be described through an example in which the filter unit 170 is positioned inside the body 110.

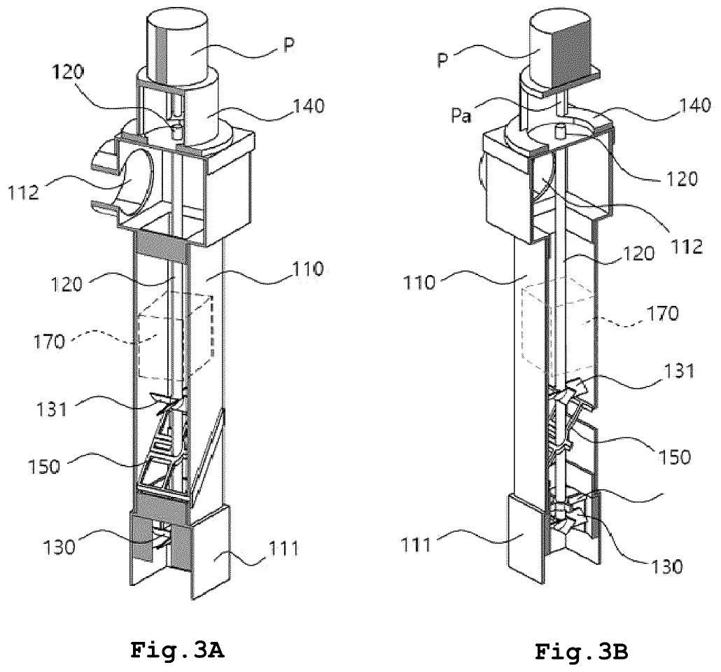

Meanwhile, the fluid W introduced into the suction port 111 may be discharged through the bottom material discharge port 113 jointly with the bottom material. As described above, the contaminants deposited on the bottom material may be peeled off from the bottom material in such a process. The present invention will be described below in more detail through FIGS. 3A and 3B jointly with the structures.

FIGS. 3A and 3B are perspective cross-sectional views of the fish bowl cleaner 100 according to an exemplary embodiment of the present invention

Referring to FIGS. 3A and 3B, the fish bowl cleaner 100 has a hollow body 110 including the suction port 111 and the water outlet 112, a driving unit P formed at one end of the body 110 and providing power, a rotary shaft 120 connected to the driving unit P, and configured and rotated in a direction of crossing a center of a longitudinal direction of the body 110, a propeller 130 coupled to the rotary shaft 120, and transporting the fluid W to the strainer 150, the discharge port 113, and the water outlet 112 through the suction port 111 as the rotary shaft is rotated by the power, and a bottom material strainer 150 positioned on a transportation path of the fluid W.

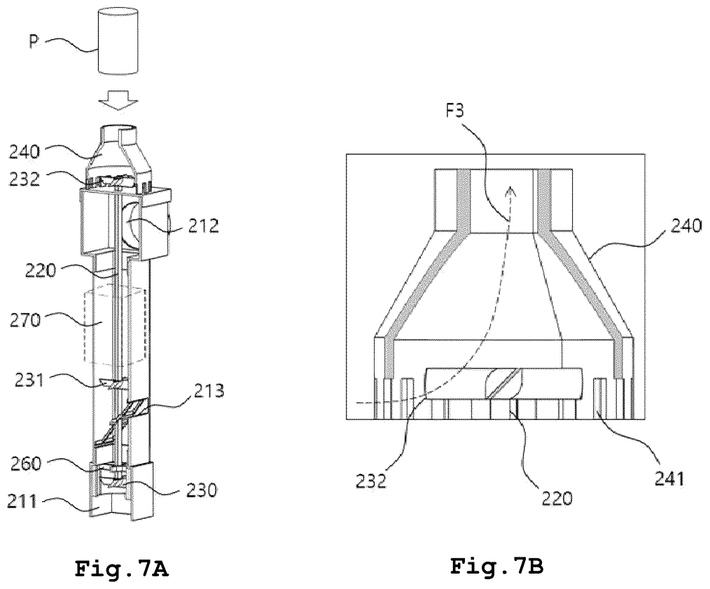

As illustrated, the driving unit P may adopt various types which may transfer the rotary force to the rotary shaft 120, and as an exemplary embodiment, may adopt an electric motor or a cleaner. In the case of FIGS. 7A and 7B, an example to which a scheme of converting energy with the rotary force by generating the suction force through the cleaner is applied is described.

Further, as illustrated in FIGS. 3A and 3B, the first propeller 130 is coupled to the rotary shaft 120 rotated by the driving unit P, and the fluid W flows forcibly according to the rotation of the first propeller 130.

Further, in the illustrated example, the fish bowl cleaner 100 further includes a second propeller 131 coupled to the rotary shaft 120 at an upper side of the bottom material strainer 150 to make the flow of the fluid W more smoothly and supply a unfiltered fluid W to the filter unit 170 installed inside the body 110 or outside the water outlet 112 more actively. Here, the unfiltered fluid includes a fluid W primarily filtered by the bottom material strainer 120, and means a fluid W not filtered by the filter unit 170.

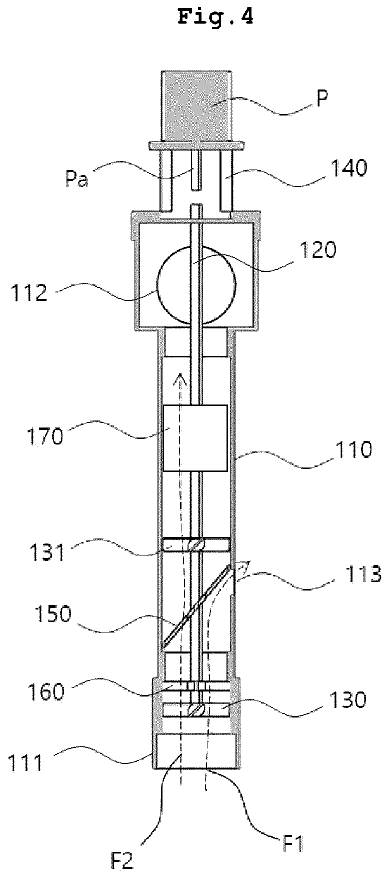

FIG. 4 is a front cross-sectional view of the fish bowl cleaner 100 according to an exemplary embodiment of the present invention.

Referring to FIG. 4, as described above, the body 110 may further include the bottom material discharge port 113 that is opened so that the floor material sucked through the suction port 111 may be discharged to the outside of the body 110.

Here, the bottom material filtered by the bottom material strainer 150 installed across the cross section of the body 110 may be discharged through the bottom material discharge port 113. As an exemplary embodiment, the bottom material strainer 150 may be installed to be tilted to the body 110, and as a result, the bottom material in the fluid W moves along the bottom material strainer 150 disposed at a predetermined slope and is discharged to the bottom material discharge port 113. Through this, clogging of the bottom material strainer 150 due to the bottom material may be prevented and the second fluid flow F2 and bottom material separated discharge may be continuously maintained.

In addition, the second propeller 131 may be installed to ensure a sufficient flow rate of water containing contaminants that pass through the bottom material strainer 150.

In addition, the fish bowl cleaner 100 may further include a support unit 160 supporting the rotary shaft 120. Here, the support unit 160 refers to a member that supports the rotary shaft 120 so that the rotary shaft does not shake due to rotational vibration and allows the rotary shaft to freely rotate in a rotation direction. In addition, a plurality of support units 160 may be installed along the rotary shaft 120 to further increase stability.

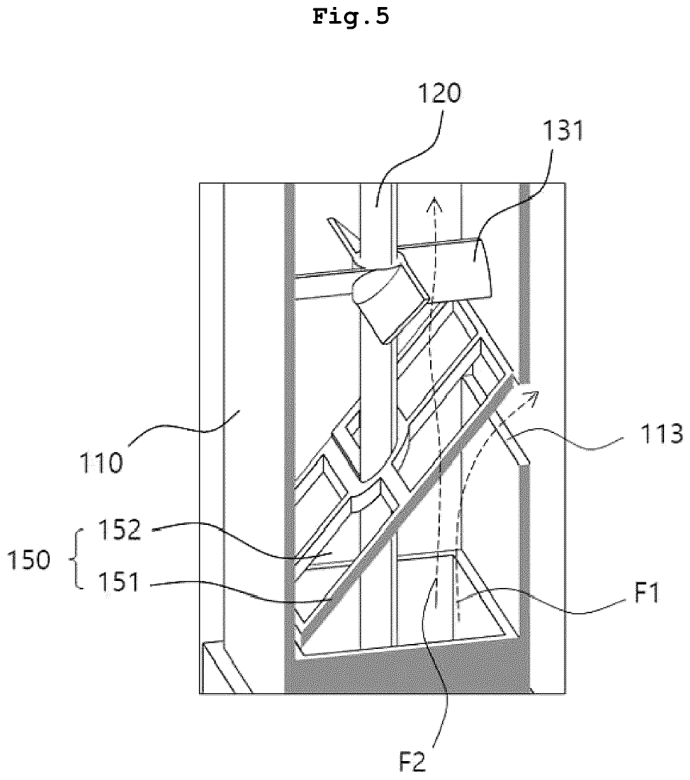

FIG. 5 is a diagram illustrating a flow W of a fluid passing through a bottom material strainer 150 according to an exemplary embodiment of the present invention

Referring to FIG. 5, the bottom material strainer 150 may be disposed to be tilted in a suction movement direction of the fluid W so that the bottom material introduced with water is guided toward the outlet 113. The bottom material strainer 150 prevents the bottom material from passing through the second fluid flow F2 and serves as a guide for transferring the bottom material together to the first fluid flow F1. As an example, the bottom material strainer 150 may include a frame 151 and a strainer 152. The strainer 152 is attached to the lower part (inlet side) of the frame 151 to prevent the bottoming material from passing through the second fluid flow F2 and to allow the bottoming material to be smoothly moved to the bottoming outlet 113. Additionally, the frame 151 may be formed to be at least close to the inner periphery of the body 110 and to be close to the outer periphery of the rotary shaft 120. Additionally, the bottom material strainer 150 may have an opening for passing the rotary shaft 120 for separation, cleaning, or assembly.

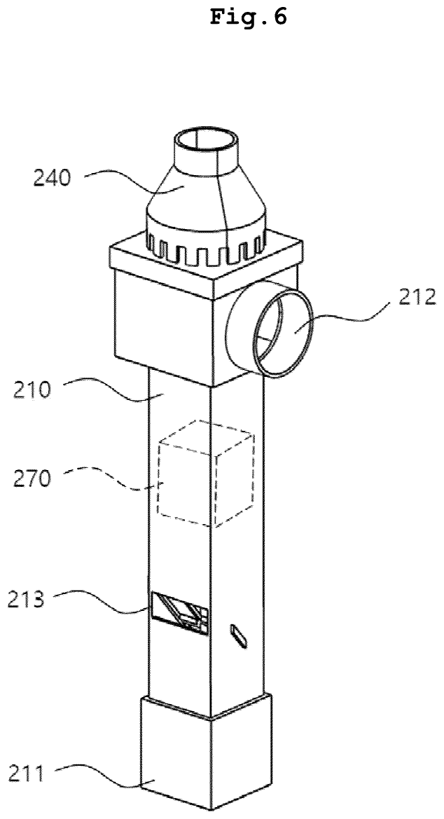

FIG. 6 is a perspective view of a fish bowl cleaner 200 according to another embodiment of the present invention

Referring to FIG. 6, the fish bowl cleaner 200 may include a body 210 in which a suction port 211, a water outlet 212, and a bottom material discharge port 213 are formed. The body 210 may allow the suction port 211 side to be immersed in the fluid W so that the fluid W is introduced into the body 210. Here, the fish bowl cleaner 200 may further include a driving unit P that provides power to allow the fluid W to flow in, and the driving unit P may be suction or discharge in an exemplary embodiment of the present invention. As a specific example, the driving unit P may be a configuration that implements one or more of intake and discharge of air, such as a vacuum cleaner or air gun. In other words, wind power is provided to suck the fluid W in the fish bowl T into the body 210. The exemplary embodiment, which is another embodiment of the present invention, may be the same as the content described above with reference to FIGS. 2 to 5 except for the configuration related to the connector 240.

Meanwhile, jointly with these structures, the present invention will be described in more detail below with reference to FIGS. 7A and 7B.

FIGS. 7A and 7B are diagrams illustrating a connector 240 connected to a driving unit P according to another embodiment of the present invention

Referring to FIGS. 7A and 7B, the fish bowl cleaner 200 may further include a driving unit P coupled to the connector 240 to generate wind power of the air, and the energy generated by the wind power from the drive unit P may be converted into rotational energy and transferred to the rotary shaft 220 in a non-contact state between the driving unit P and the rotary shaft 220 through a third propeller. Specifically, in the exemplary embodiment, when the driving unit P sucks or discharges air, the rotary shaft 220 and the third propeller, which are exposed through the body 210 inside the connector 240, are combined to rotate the rotary shaft 220. Here, in order to such the air into the connector 240 by the driving unit P connected to the inside of the connector 240 or discharged to the outside of the connector 240, the connector 240 has one or more through holes 241 to ensure smooth air flow.

That is, the fish bowl cleaner 200 may further include a driving unit P coupled to the connector 240 to generate suction force or exhaust force, and a third propeller which is formed inside the connector 240, and generates a third fluid flow F3 of air by the suction force or the exhaust force, and is positioned inside the connector 240 may be rotated. Through this, the rotary shaft 220 is rotated, and the same purpose as the exemplary embodiment described with reference to FIGS. 2 to 5 may be achieved.

Although representative exemplary embodiments of the present invention have been described in detail hereinabove, it will be appreciated by those skilled that various modifications of the exemplary embodiment of the present invention can be made in the art within a limit without departing from the scope of the present invention. Therefore, the scope of the present invention should not be limited to the exemplary embodiments and should be defined by the appended claims and equivalents to the appended claims.

What is claimed is:

1. A fish bowl cleaner comprising:
a hollow body including a suction port and a water outlet;
a connector formed at one end of the body, and connected to a means providing power;
a rotary shaft extended in a direction of crossing a hollow portion of the body, and at least partially exposed to the body, and rotated by the power; and
one or more propellers coupled to interlock with the rotary shaft, wherein at least one transports a fluid to the water outlet through the suction port as the rotary shaft is rotated by the power.

2. The fish bowl cleaner of claim 1, further comprising:
a bottom material strainer coupled to the rotary shaft to be spaced from an extension direction of the rotary shaft by an angle, and positioned on a transportation path of the fluid.

3. The fish bowl cleaner of claim 1, further comprising:
a bottom material strainer coupled to interlock with the rotary shaft to be perpendicular to an extension direction of the rotary shaft, and positioned on the transportation path of the fluid.

4. The fish bowl cleaner of claim 2, wherein the fluid is moved from the suction port to the water outlet, and a second path in which a bottom material is filtered by the bottom material strainer, and only water and contaminants are moved, and a first path in which the fluid is moved from the suction port to the bottom material discharge port, and unfiltered are simultaneously formed.

5. The fish bowl cleaner of claim 4, wherein the bottom material strainer is disposed to be tilted in a movement direction of the fluid so that the bottom material introduced into the hollow portion is guided to the bottom material discharge port.

6. The fish bowl cleaner of claim 4, wherein the fluid is moved from the suction port to the water outlet, and moved from the first path in which foreign substances are filtered by the bottom material strainer, and the suction port to the discharge port, and unfiltered.

7. The fish bowl cleaner of claim 3, wherein the fluid is moved from the suction port to the water outlet, and a second path in which a bottom material is filtered by the bottom material strainer, and only water and contaminants are moved, and a first path in which the fluid is moved from the suction port to the bottom material discharge port, and unfiltered are simultaneously formed.

8. The fish bowl cleaner of claim 7, wherein the bottom material strainer is disposed to be tilted in a movement direction of the fluid so that the bottom material introduced into the hollow portion is guided to the bottom material discharge port.

9. The fish bowl cleaner of claim 7, wherein the fluid is moved from the suction port to the water outlet, and moved from the first path in which foreign substances are filtered by the bottom material strainer, and the suction port to the discharge port, and unfiltered.

10. The fish bowl cleaner of claim 2, further comprising:
a driving unit coupled to the connector and generating rotary force,
wherein the rotary force generated from the driving unit is transferred to the rotary shaft.

11. The fish bowl cleaner of claim 10, wherein a rotary shaft of the driving unit is selectively connected and selectively spaced apart from the rotary shaft.

12. The fish bowl cleaner of claim 10, further comprising:
a driving unit coupled to the connector and generating suction force,
wherein at least one of the propellers is formed in a connector, the connector has one or more through-holes in which air is sucked by the suction force, and the propeller positioned in the connector is rotated by the air sucked into the through-hole.

13. The fish bowl cleaner of claim 3, further comprising:
a driving unit coupled to the connector and generating rotary force,
wherein the rotary force generated from the driving unit is transferred to the rotary shaft.

14. The fish bowl cleaner of claim 13, wherein a rotary shaft of the driving unit is selectively connected and selectively spaced apart from the rotary shaft.

15. The fish bowl cleaner of claim 13, further comprising:
a driving unit coupled to the connector and generating suction force,
wherein at least one of the propellers is formed in a connector, the connector has one or more through-holes in which air is sucked by the suction force, and the propeller positioned in the connector is rotated by the air sucked into the through-hole.

16. The fish bowl cleaner of claim 2, further comprising:
a support part extended from an inner surface of the body, and supporting the rotary shaft to be rotatable.

17. The fish bowl cleaner of claim 3, further comprising:
a support part extended from an inner surface of the body, and supporting the rotary shaft to be rotatable.
